(19) United States
(12) Patent Application Publication
(10) Pub. No.: US 2013/0057500 A1
(43) Pub. Date: Mar. 7, 2013

(54) CONTROL DIAL METHOD AND APPARATUS

(71) Applicant: Jeffrey Kulczycki, Plymouth, MI (US)

(72) Inventor: Jeffrey Kulczycki, Plymouth, MI (US)

(73) Assignee: KELSEY-HAYES COMPANY, Livonia, MI (US)

(21) Appl. No.: 13/697,967

(22) PCT Filed: May 16, 2011
(86) PCT No.: PCT/US2011/036596

§ 371 Date: Nov. 14, 2012

Related U.S. Application Data
(60) Provisional application No. 61/345,333, filed on May 17, 2010.

(51) Int. Cl. G06F 3/041

(52) U.S. Cl. 345/173

(57) ABSTRACT

A control dial (12, 14) includes an array of spaced sensor elements (18, 20) and a display (22) located within the dial for displaying a desired control value. A controller (30) is connected to said plurality of sensor elements and to the display for controlling an end-use device (34). The controller monitors the array of spaced sensor elements so as to determine a user desired command based on user touches to the array of spaced sensor elements. The controller (30) controls the display (22) and the end-use device (34) commensurate with the determined user desired command.

### RELATED APPLICATION

This application claims priority from U.S. Kulczycki Patent Application Ser. No. 61/345,333, filed May 17, 2010, the subject matter of which is incorporated hereby incorporated by reference in its entirety.

### TECHNICAL FIELD

The present invention relates to a control dial and is particularly directed to a touch-type control dial method and apparatus.

### BACKGROUND

Control knobs or dials, and, in particular, mechanical rotary control knobs and dials are known. Such rotary control knobs and dials are mechanically turnable and control things from a simple ON/OFF function of an end-use device, to the selection of specific items such as selection of a television or radio station. Some control knobs or dials are used to provide, what is referred to as, as an infinitely controlled function such as the volume of a radio. Such mechanical rotary control knobs and dials have been found in many vehicle control applications such as radio systems and environmental control systems such as heating, ventilation, and air conditioning (“HVAC”) systems.

### SUMMARY OF THE INVENTION

In accordance with one aspect of the present invention, a control dial comprises an array of spaced sensor elements and a display located within dial for displaying a desired control value. A controller is connected to said plurality of sensor elements and to the display for controlling an end-use device. The controller monitors the array of spaced sensor elements so as to determine a user desired command based on user touches to the array of spaced sensor elements. The controller controls the display and the end-use device commensurate with the determined user desired command.

In accordance with another aspect of the present invention, a method for controlling an end user device using a control dial comprises the steps of spacing a plurality of sensor elements in an array, displaying within the dial a desired control value, and controlling an end-use device by monitoring the array of spaced sensor elements, determining a user desired command based on user touches to the array of spaced sensor elements, and controlling the display and the end-use device commensurate with the determined user desired command.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a perspective view of a touch-type control panel in a vehicle having a driver and passenger control dials made in accordance with one example embodiment of the present invention;

FIGS. 2-7 depict a control dial made in accordance with the one embodiment of the present invention showing different possible control movements on the operator's finger on the dial; and

FIG. 8 shows a control process for a control dial in accordance with one example embodiment of the present invention.

### DETAILED DESCRIPTION

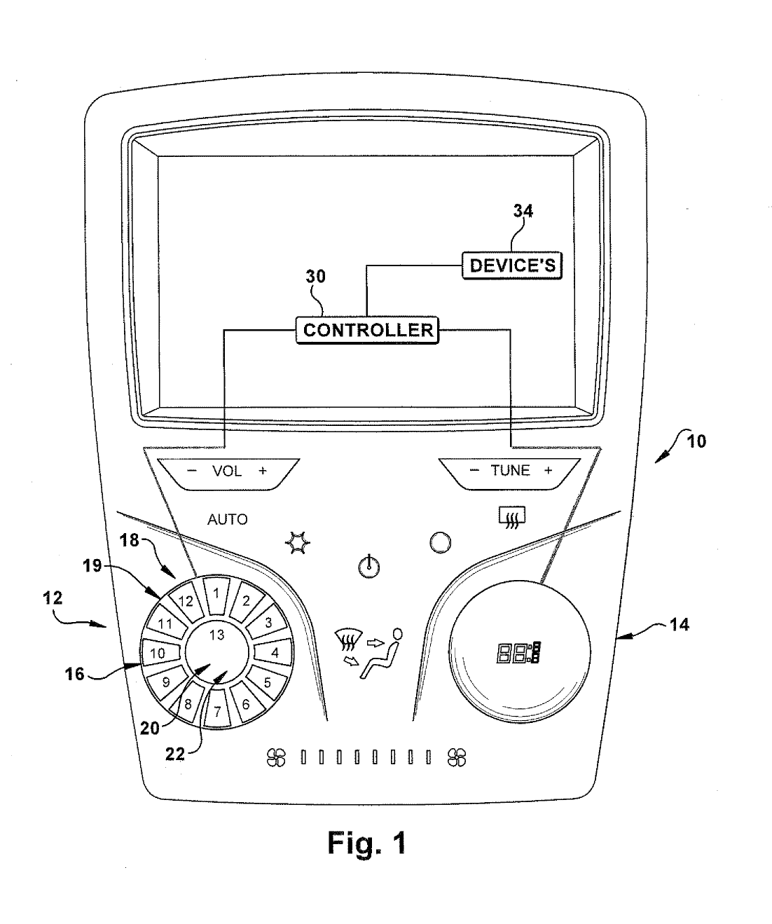

Referring to FIG. 1, a control panel 10, such as an environmental control panel for control of vehicle temperature, is shown. The control panel 10 includes a set of control dials 12, 14 made in accordance with one example embodiment of the present invention. The control dials 12 and 14 are described herein for controlling vehicle cabin temperature (driver's side and passenger's side, respectively). The dials 12, 14 are similarly constructed and function similarly. For the purposes of this application, only one control dial will be described in detail.

The use of the control dials 12, 14, although being described by way of an example embodiment for vehicle cabin temperature control, could be used to control other vehicle devices such as a radio, etc. Also, the use of the control dials 12, 14, is not limited to control of an end-user device associated with a vehicle but can be used in any control environment.

The control dial 12 may be circular in shape and mainly flat faced for flush mounting in the vehicle control panel 10. Preferably, the control dial 12 is slightly concave to allow a finger of the operator to move around the dial so as to have a more ergonomic feel. A base portion 16 of the control dial 12 is divided into a plurality of sensor segments 18 (an array of sensors) around the outer periphery 19 of the dial 12. In the example embodiment shown, the dial 12 is divided into twelve equally dispersed segments 18 which are equally spaced and distributed about the outer area or periphery of the dial 12. Any number of segments could be used with more sensors providing more control resolution. A center sensor segment 20 (e.g., a thirteenth segment) is located at substantially the center of the dial 12. The center segment 13 can have several functions. In accordance with one example embodiment of the present invention, the center segment 13 is used for sensing of a finger swipe motion across the dial 12.

The individual segments 18 and 20 of the dial 12 are not visibly apparent to the operator. If the control dial 12 is used in a HVAC application, as in this described example embodiment, an information display device 22 can be located in the dial center. Therefore, the center of the dial has both a sensor segment 20 and a display device 22. The information display device 22 can be used to provide an indication of information (such as the desired cabin temperature setting) that is visible to the user. For example, the center display device 22 can display a desired temperature setting such as 70 degrees, to indicate the desired temperature setting for the side of the vehicle cabin associated with that dial. The center dial display 22 can be any type of known display such as a digital display.

The twelve outer sensor segments 18 and the inner sensor segment 20 are, in accordance with one example embodiment of the present invention, capacitive sensors. Use of other types of touch sensors is contemplated. Each capacitive sensor segment 18 is slightly circumferentially spaced from the next adjacent sensors on each side so as to be electrically isolated therefrom. The capacitive sensor elements 18 form an array of sensor elements spread around the circumference of the dial 12. The center sensor 20 is also a capacitive sensor that is isolated from the outer sensors 18. The sensors 18, 20 are connected to a controller 30 that is, in turn, controllable connected to an end-user device 34 to be controlled. The controller 30 monitors motion of an operator's finger across and around the dial 12 and controls the end-user device 34, such as heater vent doors, the air conditioner, etc. in response to the monitored finger motion in accordance with a predetermined control process.

In accordance with the example embodiment in which the dials 12, 14 are used for control of a vehicle convenience item such as a HVAC system, the dials 12, 14 may be located on a control panel 10 located near a central front cabin location of the vehicle dash between the driver and passenger. When either the driver or passenger place their associated finger on their associated dial, in accordance with an example embodiment of the present invention, motion of the finger is detected and monitored by the controller 30 and appropriate control action occurs in accordance with a predetermined control process.

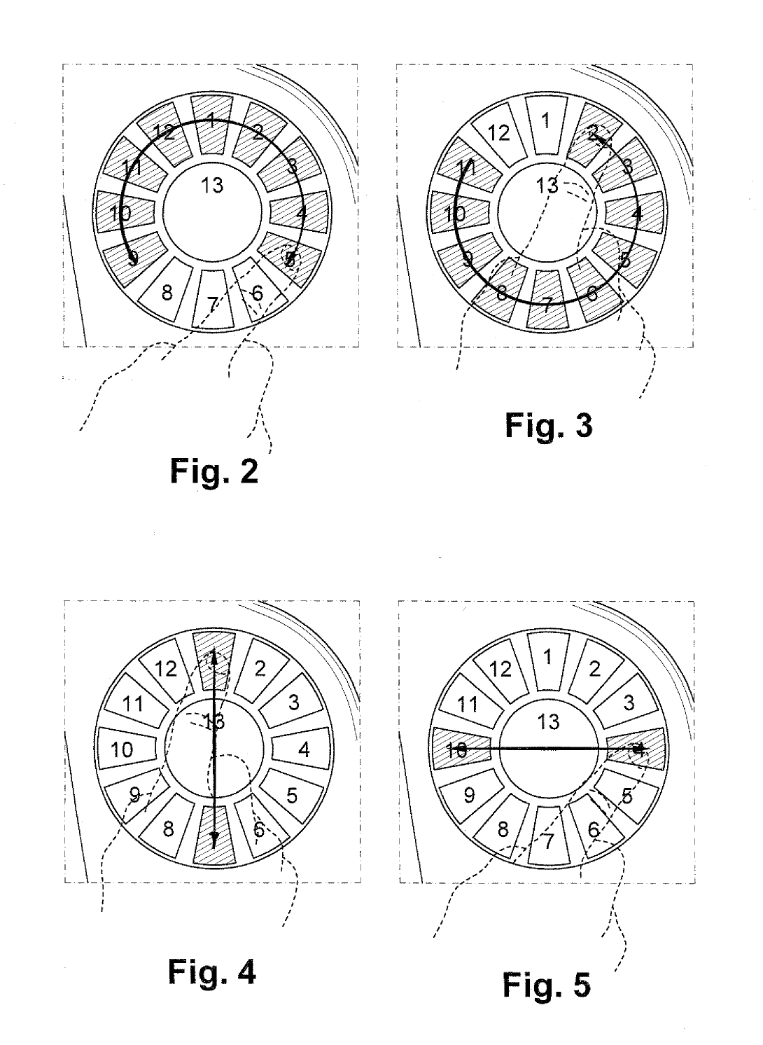

Referring to FIGS. 2-5, each of the sensor segments 18, 20 are capacitive type sensors that provide a signal when touched by a user's finger. The user's finger acts as a dielectric. As mentioned, for ergonomic reasons, the dials 12, 14 could be slightly recessed or concave.

Each capacitive sensor segment 18, 20 has an output that is connected to the controller 30. The controller 30 may take the form of a microprocessor or microcomputer, for processing of the sensor output signals and making determinations as to what type of finger motion is occurring. Alternatively, the controller 30 could be made up of a plurality of specific integrated circuits and discrete components to accomplish the desired function and can be an application specific integrated circuit (“ASIC”).

The controller 30 tracks a specific pattern of motion (finger movement) on the dial 12 and also monitors for taping motion of the finger on the dial 12. Specifically, the controller 30 determines if the user is (1) rotating his finger clockwise or counterclockwise around the dial, i.e., around the plurality of segments 18, (2) swiping his finger across or up-and-down across the dial, i.e., from one outer periphery segment to another out periphery segment through the center segment, (3) taping on the dial, or (4) providing a “flick-and-spin” or “flick-swipe” motion across the segments of the dial.

FIG. 2 specifically shows a finger motion in a clockwise motion around the outer periphery segments 18 of the dial 12. When the controller 30 determines this type of motion has occurred, temperature (assuming a HVAC system) will be increased. Display values shown on the center display 22 will be increased accordingly.

FIG. 3 specifically shows a finger motion in a counter-clockwise motion around the outer periphery segments 18 of the dial 1.2. When the controller 30 determines this pattern of motion, temperature will be decreased. Display values shown on the display 22 will be decreased accordingly.

FIG. 4 specifically shows a finger swipe across the dial 12 from one outer segment to another outer segment through the center sensor segment 20. When the controller 30 determines upward swipe motion, temperature will be jumped-up in value by a predetermined amount, such as five degrees per swipe. Display values shown on display 22 will be increased accordingly. When the controller 30 determines downward swipe motion, temperature will be jumped-down in value by a predetermined amount, such as five degrees per swipe. Display values shown on display 22 will be decreased accordingly.

FIG. 5 specifically shows a finger swipe side-to-side from one outer segment to another outer segment across the center segment of the dial 12. When the controller 30 determines this side-to-side motion, the controller can, optionally, control up and down temperature jumps by predetermined amounts (optional to up-and-down swipes) as described with reference to FIG. 4.

The controller 30 controls the center dial display 22 commensurate with the finger motion on the dial 12 in accordance with a predetermined control process as described with reference to FIGS. 2-5. Rotating the finger clockwise around the dial will cause the display to commensurately increase display values to indicate the desired temperature setting that the operator desires. Rotating the finger counter-clockwise around the dial will cause the display to commensurately decrease display values to indicate the desired temperature setting that the operator desires. Cross-swipes (up/down, left/right) jumps the display temperature values by a predetermined amount, e.g., 5 degrees up/down. In response to the finger motions, not only does the controller 30 control the display device, it also controls the end-user device commensurately to achieve the operator desired temperature setting.

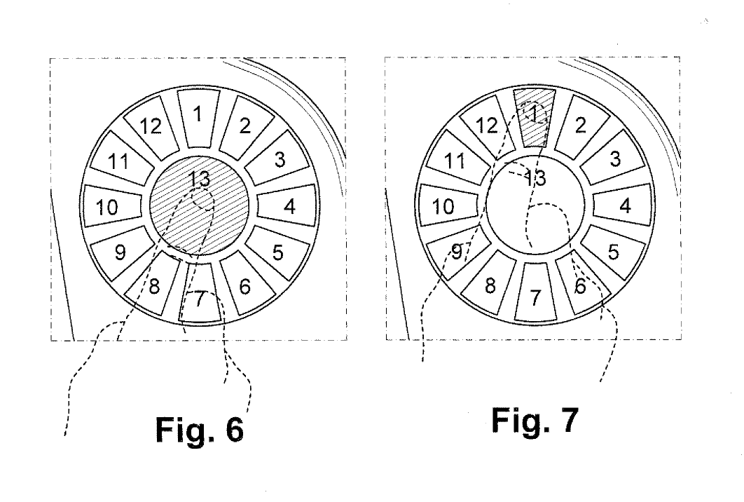

Referring to FIG. 6, a single tap to the center sensor 20 by the operator's finger can result in any desired control of the system. Pressing and holding the center sensor 20 can also result in any desired control. For example, taping the center sensor can be used to change the display units between Fahrenheit and Celsius readings.

FIG. 7 depicts a signal tape of the operator's finger on the dial near the top of the dial which the controller 30 can sense and provide desired control such as increasing temperature (and display value) one degree at a time (one degree per tap). Pressing and holding a sensor segment, such as near the top of the dial 12, can advance the desired temperature quickly one degree at a time. Similarly, pressing and holding the bottom segment of the dial 12 can decrease the desired temperature setting accordingly.

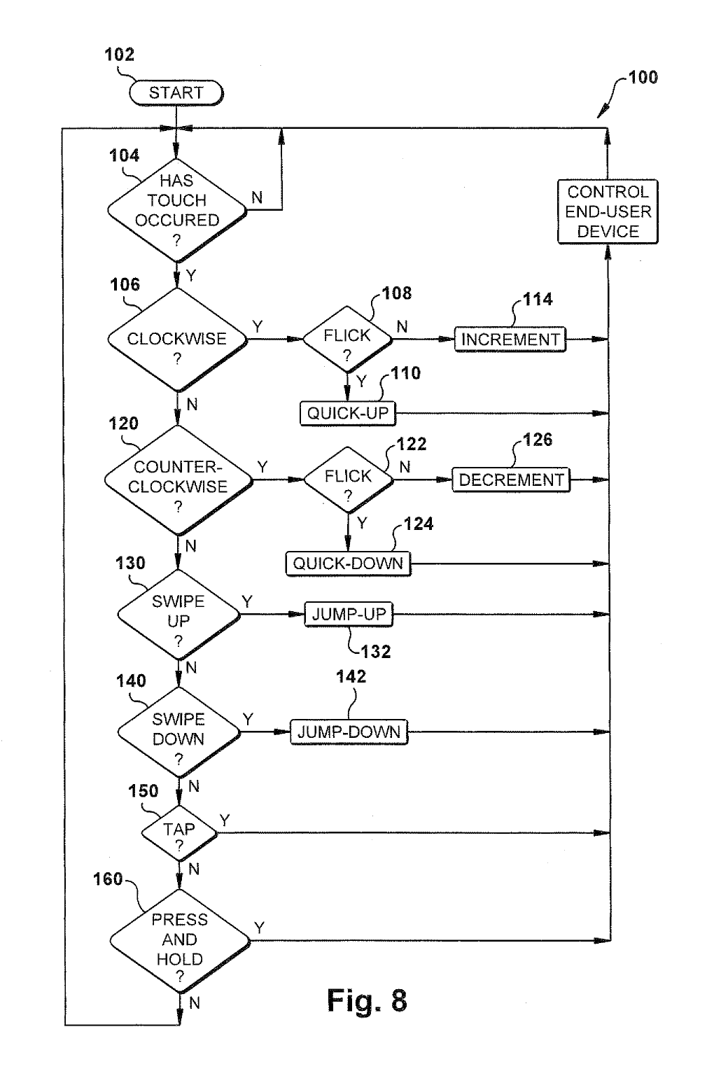

Referring to FIG. 8, a control process 100, in accordance with an example embodiment, for using a control dial of the present invention is shown. The control process 100 is for one control dial. If multiple dials are used, a control process would be provided for each dial. The control process 100 starts at step 102 where initial flags are set, memories cleared, and initial control conditions are set. In step 104, a determination is made as to whether a finger touch to the dial has been sensed, i.e., whether any of the plurality of control dial sensors is providing a signal indicating contact by an operator's finger. If the determination in step 104 is negative, the process loops back until an affirmative determination is made.

If the determination in step 104 is affirmative, the process proceeds to step 106 where a determination is made as to whether a clockwise finger motion has been detected around the plurality of outer periphery sensors 18. If the determination in step 106 is affirmative, the process proceeds to step 108 where a determination is made as to whether the clockwise finger motion is a finger-flick motion, i.e., rapid clockwise rotation. If the determination in step 108 is affirmative, the display 22 is quickly incremented according to the degree and speed of the sensed flick motion in process step 110. The controller 30 then controls the end user device accordingly in step 112, i.e., control the end user device 34 to increase the cabin temperature to correspond to the temperature setting value set on the display 22. The process then returns to step 104. If the determination in step 108 is negative, the display 22 is incremented commensurate with the finger motion movement in step 114. The controller 30 controls the end-user device 34 in step 112 commensurate with the value set on the display 22.

If the determination in step 106 is negative, the process proceeds to step 120. In step 120, a determination is made as to whether a counter-clockwise motion has been detected. If the determination in step 120 is affirmative, the process proceeds to step 122 where a determination is made as to whether the counter-clockwise finger motion is a finger-flick motion, i.e., rapid counter-clockwise rotation. If the determination in step 122 is affirmative, the display 22 is quickly decremented according to the degree and speed of the flick motion in process step 124. The controller 30 then controls the end-user device 34 accordingly in step 112 so as to decrease the cabin temperature commensurate with the value on the display 22. The process then returns to step 104. If the determination in step 122 is negative, the display 22 is decremented slowly following the finger motion movement in step 126 and the controller 30 controls the end-user device 34 in step 112 so that the cabin temperature is commensurate with the display value.

If the determination in step 120 is negative, the process proceeds to step 130. In step 130, a determination is made as to whether a swipe-up motion has been detected. Recall that a swipe motion is type of finger motion across the dial as depicted in FIG. 4. If the determination in step 130 is affirmative, the process proceeds to step 132 where the display value shown on display 22 is jumped-up a predetermined amount, e.g., five degrees/per swipe. The controller 30 then controls the end-user device 34 accordingly in step 112 and the process then returns to step 104.

If the determination in step 130 is negative, the process proceeds to step 140. In step 140, a determination is made as to whether a swipe-down motion has been detected. If the determination in step 140 is affirmative, the process proceeds to step 142 the display value shown in display 22 is jumped-down a predetermined amount, e.g., five degrees/swipe. The controller controls the end user device accordingly in step 112 and the process then returns to step 104.

If the determination in step 140 is negative, the process proceeds to step 150. In step 150, a determination is made as to whether a tape to the center of the control dial, i.e., sensor segment 20, has been detected. If the determination in step 150 is affirmative, the controller controls the display 22 so as display values such as between Fahrenheit or Celsius. Any adjustments are then made to the end-user device, if necessary, in step 112 and the process then returns to step 104. As mentioned, taps to the upper or lower portion of the dial can be sensed and temperature values incremented or decremented accordingly.

If the determination in step 150 is negative, the process proceeds to step 160. In step 160, a determination is made as to whether a press and hold to any portion of the control dial has been detected. If the determination in step 160 is affirmative, the controller 30 controls the end user device in step 112 in accordance with any desired manner and/or the dial 12, e.g., incrementing or decrementing temperature values until the “hold” s released. The control process then returns to step 104.

The desired control process 100 followed by the controller 30 in response to finger movements, swipes (up, down, left, right), flicks, taps and/or press and holds on the dial can be those described or any other desired end-user device response. Also, the function of the dials 12, 14 can be changed such as controlling vehicle cabin temperature, controlling fan speeds, controlling radio volume and/or radio stations. A function control button on the control panel, such as radio volume, radio station, fan speed, etc. could be provided so that when such function control button is tapped, the controller 30 will switch the control function of the dial so as to control a commensurate end-user control device associated with that dial accordingly. Alternatively, the dials 12, 14 could be single purpose control dials so as to control only a single device such as the HVAC system for an associated side of the vehicle.

From the above description of the invention, those skilled in the art will perceive improvements, changes and modifications. The control dial of the present invention and the control process in accordance with the present invention can be used to replace any mechanical rotary control knob whether in a vehicle system or any non-vehicle system. Improvements, changes and modifications within the skill of the art are intended to be covered by the appended claims.

Having described the invention, the following is claimed:

1. A control dial comprising:
an array of spaced sensor elements;
a display located within the dial for displaying a desired control value; and
a controller connected to said plurality of sensor elements and to the display for controlling an end-use device, said controller monitoring the array of spaced sensor elements so as to determine a user desired command based on user touches to the array of spaced sensor elements, said controller controlling the display and the end-use device commensurate with the determined user desired command.

2. The control dial of claim 1 wherein the dial is circular and the array of spaced sensor elements includes a plurality of sensor elements circumferentially space around the dial and a center sensor element located at substantially the center of the dial.

3. The control dial of claim 2 wherein the display is located at substantially the center of the dial.

4. The control dial of claim 2 wherein said array of spaced sensor elements are capacitive sensors.

5. The control dial of claim 1 wherein the end-user device is a vehicle heating, ventilating, and air conditioning system and wherein said control dial controls said vehicle heating, ventilating, and air conditioning system in accordance with the user determined desired command.

6. The control dial of claim 5 wherein said controller monitors the array of spaced sensor elements for clockwise and counter-clockwise finger motion across the array of spaced sensor elements so as to determine a user desired temperature increase for clockwise finger movement and determine a user desired temperature decrease for counter-clockwise finger movement.

7. The control dial of claim 5 wherein said controller monitors the array of spaced sensor elements for swiping finger motion across the array of spaced sensor elements so as to determine a user desired temperature change by a predetermined incremental amount.

8. The control dial of claim 5 wherein said controller monitors the array of spaced sensor elements for clockwise and counter-clockwise finger flick motion across the array of spaced sensor elements so as to determine a user desired predetermined incremental temperature increase for clockwise finger flick movement and determine a user desired predetermined incremental temperature decrease for counter-clockwise finger flick movement.

9. The control dial of claim 5 wherein said controller monitors the array of spaced sensor elements for a finger tap to the array of spaced sensor elements so as to determine a user desired function responsive to the finer tap.

10. A method for controlling an end user device using a control dial comprising the steps of:
spacing a plurality of sensor elements in an array;
displaying within the dial a desired control value; and
controlling an end-use device by monitoring the array of spaced sensor elements, determining a user desired command based on user touches to the array of spaced sensor elements, and controlling the display and the end-use device commensurate with the determined user desired command.
